(19) United States
(12) Patent Application Publication
(10) Pub. No.: US 2013/0326336 A1
(43) Pub. Date: Dec. 5, 2013

(54) GENERATING SEMANTIC STRUCTURED DOCUMENTS FROM TEXT DOCUMENTS

(71) Applicants: Michel Lanque, Nozay (FR); Philippe Larvet, Lamonzie-M. (FR)

(72) Inventors: Michel Lanque, Nozay (FR); Philippe Larvet, Lamonzie-M. (FR)

(73) Assignee: ALCATEL LUCENT, Paris (FR)

(21) Appl. No.: 13/992,875

(22) PCT Filed: Nov. 30, 2011
(86) PCT No.: PCT/EP2011/071353

§ 371 Date: Aug. 19, 2013

(30) Foreign Application Priority Data
Dec. 9, 2010 (FR) 1060320

(51) Int. Cl. G06F 17/21

(52) U.S. Cl. CPC G06F 17/218
USPC 715/234

(57) ABSTRACT

A device (CGM) for generating a file (DS) in accordance with a grammar from a text document (D1, D2) containing structural data, comprising first means for creating structural labels from structural data, second means for creating semantic labels from a semantic analysis of the content, third means provided to associate the structural labels and the semantic labels in order to form label aggregates, fourth means for generating the file from these label aggregates by using predefined associations between aggregates and elements compliant with the grammar.

The present invention relates to generating technical documents. It particularly applies to documentation related to complex products, composed of a large number of components, and notably documentation delivered to the user of these products. It may also apply to other types of documentation specific to the world of industry.

This documentation may be hard copy documentation, but may also be on-board documentation (contextual online help, etc.).

This product or management documentation, etc., is generally composed of a document structure dealing with the format and presentation (being divided into chapters, subchapters, etc.), and a content structure related to the product in the process associated with the product (use case, features, settings, etc. for a product; management of source data, development, test, integration, delivery, etc. for the process).

The design and development of the elements that compose the product may be assigned to separate development teams. Furthermore, as time goes by, different generations of products may be sold, and the people responsible for the documentation are not necessarily the same from one generation to another.

For this reason among others, it is important to adopt a logical approach to generating documentation.

Generally speaking, the writing style of technical documentation meets several types of requirements:
requirements related to the formalism of the industrial processes (the structure of the product to be developed, the transmission of reference information for development, the tests, etc.)
compliance with international certifications, which provide proof that information is accessible and available,
legal requirements, as the company is liable to its clients for this technical documentation,
knowledge of all of the product components (including external components, such as open-source components) by the authors of the document content.

Different international certifications exist, which may be divided into two families:
that which pertains to linear content, such as DocBook, standardized by the OASIS (Organization for Advancement of Structured Information). This linear content is intended for publications in formats such as books, manuals, brochures, etc.
that relate to an arrangement of structured content. They include the OASIS's DITA (Darwin Information Typing Architecture) standard, or the international ISO/IEC 26514 standard entitled “Systems and software engineering—Requirements for designers and developers of user documentation”

DITA makes it possible to model information based on its semantics, and organizes it in the form of topics, which may be generic (“topics”), concepts, tasks, or references. Once the information has been modeled, an architecture compliant with DITA is capable of deriving different document content from it for release: websites (HTML documents), ready-to-print documentation, PDF documents, Java or Oracle help files, etc.

There are many products that use the DITA standard. They include the software FrameMaker from the company Adobe, software from the company Quark, Arbortext, SoftQuad Xmetal, etc.

Creating content compliant with DITA consists of writing the content in the form of topics, and describing maps that link these topics. These maps may be seen as a kind of table of contents, defining a given document content for release. Topics and maps are XML (eXtensible Markup Language) files as defined by W3C (World Wide Web Consortium).

More precisely, they are “XML schema” files. An XML Schema is an XML file that contains the definitions of its component elements.

It is theoretically possible to write XML schema files using an XML editor.

However, this approach does have its shortcomings.

First, the XML formalism is hard for a non-specialist to manipulate. In practice, only technical documentation professionals use XML editors to develop documentation.

However, in many situations, the technical documentation's author is not a specialist in the XML language. At the same time, companies are seeking to lower their costs, often doing so by lowering costs related to human resources profiles. In such cases, they seek to limit these honed skills, in order to replace them with less technically qualified people or by allocating time to the product development teams in order to author the documentation, or at least part of it.

Even for a person who knows the XML language well, using it to write documentation is impractical and time-consuming.

Although other people must be involved in authoring the documentation at an earlier stage (managers, marketing department, communications department, etc.), each one must be capable of understanding the XML document, which is obviously too great a requirement.

Writing an XML document often takes longer than writing a simple documentation text.

Consequently, the writing of technical documentation generally derives from a structured text document editor, such as the software Word from the company Microsoft. Computer files that contain not only raw text but also a structure organizing the text are hereinafter referred to as “structured text files”. For example, it is possible to associate a level with some portions of text. This level may be given by a style, for example a title level. It may also be indentation, which may give the indented text a lower level, etc.

Furthermore, whenever it is desired to generate a DITA documentation for a given generation of products, it is highly likely that there had already been text documentation for the previous generation. It is therefore beneficial to be able to draw from the existing documentation, in order to limit the time and cost needed to author the technical documentation.

Consequently, from a text document, it may be beneficial to generate not only a technical documentation (or a module of a technical documentation) compliant with a standard such as DITA, but also a structural document. This is a structural document models the content of the original text document and of the product technical documentation's module.

The structural document makes it possible, among other things, to compare different versions of the same information module, and to determine the evolutions, changes, and consequently, the impact on the resulting technical documentation of a new version of the corresponding product.

This structural document is typically compliant with an XML schema grammar or DTD grammar.

Additionally, tools have been developed to generate XML schema files from Microsoft Word documents.

For example, the tool Quark Dynamic Publishing Solution (DPS) makes it possible to create DITA content from MS Word with transparent management of the XML layer.

More generally speaking, there are tools and mechanisms that make it possible to derive an information structure from raw content.

For example, the article “DTD-miner: A Tool for Mining DTD from XML Documents” by Chuang-Hue Moh, Ee-Peng Lim, and Wee-Keong Ng describes the extraction of a DTD (Document Type Definition) from an XML file. However, this DTD-Miner tool is based only on the structure of the input XML file. It is therefore essential that this file's structure meets the requirements of the intended output structure. It considers an already-structured document expressed in XML as its input, not an open-format text.

However, such tools are based only on the original document's structure (chapters, some chapters, etc.) and do not take into account that document's semantic content. They only meet some of the industrial needs, and therefore do not enable people in charge of the documentation to bypass a form of manual labor that is time-consuming, expensive, and subject to errors.

It is an objective of the invention to improve the situation by proposing a method and device for generating, from a text document, a DTD or XML schema structural document, incorporating semantic aspects in addition to purely structural aspects.

In order to do so, a first object of the invention is a method for generating a file compliant with a grammar based on a text document containing structural data, comprising
a first step of creating structural labels from this structural data,
a second step of creating semantic labels from a semantic analysis of the text document's content,
a third step of associating the structural labels and the semantic labels in order to form label aggregates,
a fourth step of generating the file from these label aggregates by using predefined associations between aggregates and elements compliant with the grammar.

According to one embodiment of the invention, the second step consists of extracting concepts from the content and of determining the semantic labels from the concepts and from an ontology.

This ontology may be provided by an outside service.

The concepts may be determined as being the most frequent ones.

The grammar may be an XML schema grammar, or a DTD grammar.

According to one embodiment, each step of the inventive method is carried out line by line.

It is also an object of the invention to have a computer program comprising means for, whenever implemented on an information processing device, executing the method described above.

A further object of the invention is a memory medium intended for a computer running this program. This memory medium may be an optical disc such as a CD-ROM, DVD, Blu-Ray, etc., a memory card, a USB key, etc.

A further object of the invention is a device for generating a file compliant with a grammar from a text document containing structural data, comprising
first means for creating structural labels from structural data,
second means for creating semantic labels from a semantic analysis of the content,
third means provided to associate the structural labels and the semantic labels in order to form label aggregates,
fourth means to generate said file from the label aggregates by using predefined associations between aggregates and elements compliant with said grammar.

This device may be incorporated into a hardware element, such as a computer used as a server in a communication network.

Thanks to the means of the invention, the XML schema or DTD structural documents make it possible to track the document's evolution, with respect to both its structural and semantic aspects.

The invention additionally makes it possible to detect and correct inconsistencies between the structural and semantic information.

The invention and its benefits will become more clearly apparent in the following description, with reference to the attached figures.

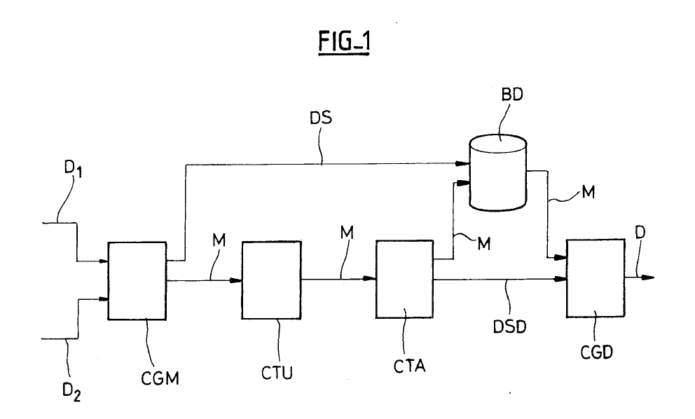

FIG. 1 diagrams a global process into which the previously described method may be incorporated.

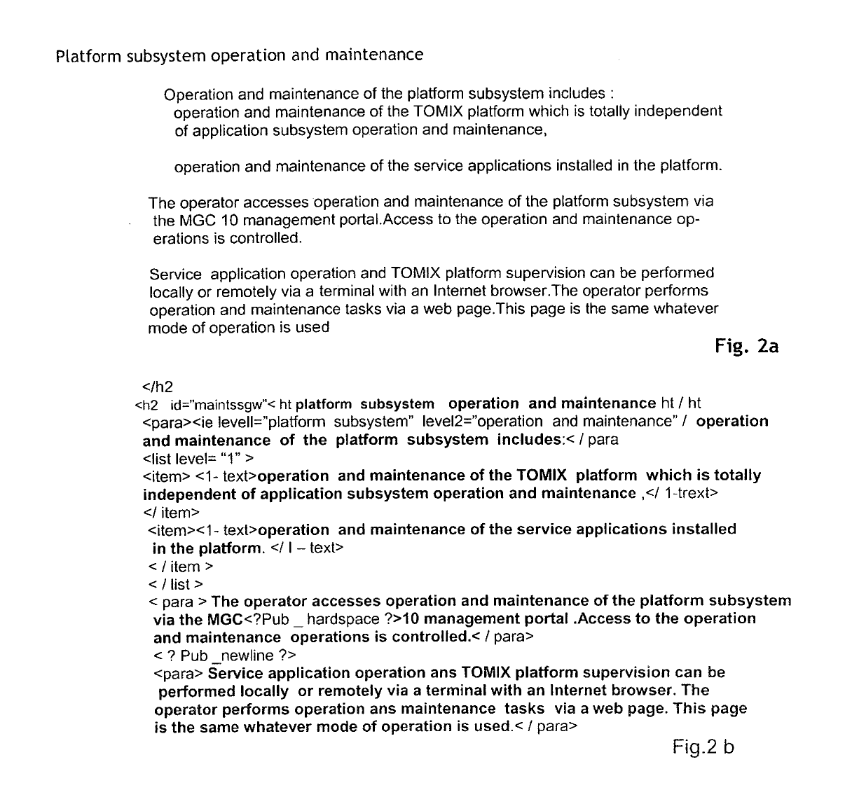

FIGS. 2a and 2b illustrate a concrete example of a text document and XML schema file produced by the invention.

The global process into which the invention fits comprises a first step of generating information modules. In FIG. 1, this first step may be implemented by a module-generating software component CGM.

This step accepts as inputs the documents D1 entered by the technical authors, or previously existing documents D2, and may be compliant with the previously described mechanism. It therefore generates information modules M in XML format.

Furthermore, the module-generating component additionally produces structural documents DS. These components contain a structural and semantic modeling of the corresponding information modules M. These are files that comply with a grammar. Here, grammar refers to a set of rules defining a file structure. This grammar may be an XML schema grammar or DTD grammar (Document Type Definition).

The information modules M may be tested by a unit testing software module CTU. The purpose of the test module is to ascertain that the information module M meets predefined quality criteria.

These quality criteria may rely on the compliance of management data with respect to metadata (identifier, domain, etc.), approving the informational content on technical, linguistic, and stylistic levels, approving the module's reusability status as a single non-editable source, etc.

The tested information modules may then be transmitted to an architectural testing software component CTA. The purpose of this component is to verify that all the information modules are consistent, based on consistency criteria (the consistency of the exchanged data, event exchanges, sequence of operations, functional or structural links with the other modules, reuse i.e. the same module belonging to a different document, etc.)

The architectural testing software component CTA may also produce structured documentation data DSD, meaning something akin to a table of contents of the document that will be produced.

The information modules M that have passed this consistency approval step may then be saved in a database BD.

The database BD may be structured to save associations in a structural document DS and an information module M.

One of the noteworthy advantages of this approach is that if part of the overall product is modified for a new version, for a customization for a given client or for any other reason, only the associated information module may be impacted. It will therefore follow all the steps up to saving within the database BD. The other information modules related to the product's other parts might not be reprocessed.

Whenever a new documentation must be produced, a documentation-generating software component CGD uses the structured documentation data DSD to build the documentation “on-demand.”

As previously noted, data DSD form a table of contents for the documentation D to be generated. Owing to this data DSD and to the structural documents DS saved in the database BD, is possible to retrieve the associated information models M. The software component CGD then assembles the information modules M according to rules given by the structural data DSD, thereby forming a documentation D for the client that complies with the product's most recent vision.

At the start of the chain, the documents processed at the input D1, D2 are text documents containing structural data.

It may be a document derived from word processing, such as the software product Microsoft Word. It may also be a document in HTML (HyperText Mark-up Language) format. Other types of documents may also fall within the scope of the invention, provided that they are documents containing text and structural elements (tags, labels, etc.).

The structural data complete the text by providing information about hierarchical structuring levels (chapters, some chapters, paragraphs, etc.) or about structures that are not hierarchically linked such as tables, images, etc.

The invention pertains to the mechanism consisting of translating these text documents into structural documents DS (i.e. DTD or XML schemas).

According to one embodiment of the invention, the document D1, D2 is converted into HTML format (if it had not already originally been in this format). This conversion is immediate, as products like Microsoft Word make it possible to export the opened document in HTML format.

Other implementations may handle different types of formats. Incorporated into a word processing product, the invention may particularly handle that product's proprietary format.

In this HTML format, the structural data is made up of HTML tags such as <h1>, <h2>, <h3>, <p>, <table>, <tr>, <td>, <img>, etc. The first 4 tags (or marks) indicate hierarchical levels, respectively three levels of headers and one paragraph tag. The tag <table> inserts a table, the tag <tr> a row within a table, and the tag <td> a cell. The tag <img> indicates an image.

Other tags exist and may be handled by the invention.

According to one preferential embodiment of the invention, the module-generating software component CGM handles the document D1, D2 (or its conversion into HTML format) portion by portion. In an implementation based on HTML format, these portions may be HTML rows.

If so, a first step consists of creating structural labels based on structural data contained within the handled document.

Similarly to a web browser, it may therefore involve isolating the HTML tags, then associating each type of tag with a structural label. One schema that makes it possible to create these structural labels may be as follows:

<h1> → title
<h2> → subtitle_2
<h3> → subtitle_3
<p> → paragraph
<table> & <tr> → table_line
<table> & <td> → table_cell
<img> → image

For the paragraph, a test may be added in order to check whether or not the row is blank. If it is, the structural label “paragraph” might not be generated.

The terms used for these structural labels (title, subtitle_{—}2 . . . ) are purely arbitrary. The only restriction is that they be adopted by the software components that use the generated document modules M.

A second step consists of creating semantic labels from a semantic analysis of the content of the document D1, D2. As in the previous step, this step may be carried out portion by portion, and particularly HTML line by HTML line.

This semantic analysis may consist of extracting one or more concepts from this content. These extracted concepts may be the concepts most representative of the HTML line. Different embodiments, obviously, are possible.

For example, it is known in and of itself to extract a cloud of keywords from a piece of text content By way of example, the work of the Signifia team may be mentioned: http://www.signifia.com

In this case, it is possible to order them by their frequency of occurrence in the HTML line in question: the concepts extracted shall, in such a case, be the most frequent N keywords. A parameter may determine this number N. Depending on the content of the line in question, a lower number of concepts may be extracted. For example, an occurrence threshold may be conceived, beneath which the concept is not adopted.

The concept generated in this way may be “generalized” by means of an ontology in order to provide semantic labels. This ontology may be provided by a service external to the inventive device. In particular, it may be accessible via the Internet.

Many projects exist for providing ontologies over the Internet. In particular, the work available on the website of the University of Maryland UMBC, at the address http://swoogle.umbc.edu, may be mentioned.

It may also be a proprietary ontology, suitable for the products associated with the documentation to be generated.

These ontologies are structured sets of terms representing a field of knowledge: they make it possible to manage various semantic relationships between terms: synonyms, generalizations, inclusions, etc.

Among other inventors, this subset makes it possible to make the semantic labels independent of the terminology specific to the author of the document D1, D2 (or the portion in question of that document). It thereby makes it possible to ultimately obtain consistent structural documents DS.

It is thereby possible to compare different versions of a structural document DS in order to draw conclusions about the product's evolution, etc.

A third step consists of associating the structural labels and the semantic labels to create label aggregates.

Once again, different implementations are possible. For example, for each HTML line, it is possible to create pairs of labels, made up of the structural label determined during the first step and a semantic label. Thus, if N semantic labels have been attracted, N pairs of labels are generated.

In other words, for each line, a data structure is obtained in the format: {(line_semtag; concept_semtag1), (line_semtag; concept_semtag2) . . . }, in which “line semtage” represents the structural label and “concept_semtag1”, “concept_semtag2” represent the semantic labels.

Another approach might be to associate each HTML line with its corresponding structural label and the set of semantic labels. For each line, a data structure is obtained in the format (line_semtag; concept_semtag1; concept_semtag2 . . . )

Finally, a fourth step generates the structural document DS from these label aggregates by using predefined associations between aggregates and elements compliant with the grammar associated with the information module M. This grammar, as previously stated, may be the grammar of XML schema, DTD, or potentially other languages. In particular, it may be compliant with the DITA standard.

These predefined associations may be saved in a lookup table, which is internal or external to the module-generating software component CGM.

FIGS. 2a and 2b show one example conversion of a text document into an XML schema file, in accordance with the invention.

FIG. 2a shows a text document written in natural English. It is a paragraph regarding the maintenance of a system platform.

FIG. 2b shows the resulting XML schema file. It includes the XML elements corresponding to the structural labels <para>, <h2>, <list> . . . and associated with elements <ie level1=“platform subsystem” level2=“operation and maintenance”> corresponding to semantic labels, which had resulted from the semantic analysis of the file's content (FIG. 2a).

It is thereby possible, in particular, to analyze the documentation's consistency with the elements derived from the semantic labels “platform subsystem” and “operation and maintenance” and those resulting from the corresponding structural labels “<ht> Platform subsystem Operation and Maintenance”>

Furthermore, it is easy to compare two iterations of the same initial documentation by using the structural and semantic labels to analyze the differences.

One example of a possible algorithm for generation according to the invention is given below in pseudocode:

```
Convert document into HTML
For each HTML line
  extract content of the line lineContent
  Select HTML mark
  <h1> line_semtag = title
  <h2> → line_semtag = subtitle_2
  <h3> → line_semtag = subtitle_3
    <p> → if not(lineContent.equals( [symbol]  &amp nbsp;″)) line_semtag =
    paragraph
  <table> & <tr> → line_semtag = table_line
  <table> & <td> → line_semtag = table_cell
  <img> → line_semtag = image
  etc.
  end_select
  ArrayOfConcepts = extract_pertinent_concepts_from (lineContent)
      ArrayofMostFrequentConcepts =
    determine_most_frequent_concepts_from(ArrayOfConcepts)
  For each concept in ArrayOfMostFrequentConcepts
        Associate a concept_semtag to the concept
      depending on a external ontology.
      semantic_couple = concat (line_semtag, concept_semtag)
  end_for
end_for
for each element on the list,
  create DTD element or XML schema element according to an external
  correspondance table: semantic_couple element
end_for
```

1) A method for generating a file in accordance with a grammar based on a text document containing structural data, comprising
a first step of creating structural labels from said structural data,
a second step of creating semantic labels from a semantic analysis of said content,
a third step of associating said structural labels and said semantic labels in order to form label aggregates,
a fourth step of generating said file from said label aggregates by using predefined associations between aggregates and elements in accordance with said grammar.

2) A method according to claim 1, wherein said second set consists of extracting concepts from said content and of determining said semantic labels from said concepts and from an ontology.

3) A method according to claim 1, wherein said ontology is provided by an outside service.

4) A method according to claim 2, wherein said concepts are determined as being the most frequent.

5) A method according to claim 1, wherein said grammar is an XML schema grammar.

6) A method according to claim 1, wherein said grammar is a DTD grammar.

7) A method according to claim 1, wherein each step is carried out line by line.

8) A computer program comprising means for, whenever implemented on an information processing device, executing the method according to claim 1.

9) A memory medium intended for a computer comprising the product according to claim 1.

10) A device for generating a file in accordance with a grammar from a text document containing structural data, comprising
first means for creating structural labels from said structural data,
second means for creating semantic labels from a semantic analysis of said content,
third means provided to associate said structural labels and said semantic labels in order to form label aggregates,
fourth means to generate said file from the label aggregates by using predefined associations between aggregates and elements compliant with said grammar.

11) A hardware element comprising a device according to claim 1.
